(19) United States
(12) Patent Application Publication
(10) Pub. No.: US 2005/0258135 A1
(43) Pub. Date: Nov. 24, 2005

(54) Method of cutting glass substrate material

(76) Inventors: Hirokaza Ishikawa, Shinagawa-ku (JP); Toshio Hayashi, Nerima-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/519,256

(22) PCT Filed: Nov. 17, 2003
(86) PCT No.: PCT/JP03/14592

§ 371 Date: Dec. 27, 2004

(30) Foreign Application Priority Data
Nov. 19, 2002 (JP) 2002-335293

(51) Int. Cl. B29D 11/00

(52) U.S. Cl. 216/24

(57) ABSTRACT

There is provided a method for cutting a glass substrate member capable of cutting the glass substrate member while forming a scribe line with a “scriber” and also obtaining a high-quality and hard-to-chip cutting plane. The cutting method for the glass substrate member according to the present invention comprises a removing step for removing a part or whole of a back surface portion of the glass substrate member; and a scribing step for forming a scribe line that produces a crack on a front surface of the glass substrate member. The crack extends to a back surface of the glass substrate member.

### TECHNICAL FIELD

The present invention relates to a method for cutting a glass substrate member.

### BACKGROUND ART

For example, a liquid crystal display is generally fabricated by sealing two thin glass substrates at their periphery with a sealant and injecting liquid crystal between the glass substrates. An organic EL display is generally fabricated by deposition-forming thin films such as electrodes and luminescent layers on a thin glass substrate by deposition or the like

A glass substrate used for such a display is required to be smooth, free of undulation and thin. Typical methods of manufacturing glass include, for example, a floating method of pouring glass onto melted tin to form glass in the form of plate and a down-drawing method of discharging melted glass from a furnace and drawing it from a slit between rollers.

Through the above-mentioned manufacturing processes, the glass is manufactured in the form of glass substrate members having a predetermined thickness and size, which are called “mother glass”, and then shipped. The larger the mother glass, the more display panels can be cut therefrom. For the cutting of each display panel, there is adopted a method of putting a scratch on the mother glass according to the size of each display panel and splitting the glass under pressure. An apparatus for putting such a scratch is called a “scriber” and an apparatus for splitting the glass under pressure is called a “breaker” (refer to Japanese patent Application Laid-Open 2002-37638, for example). The breaker taps the back surface of the glass substrate member to expand the scratch, which is formed on the front surface, in the direction perpendicular to the front surface so as to reach finally the back surface.

With respect to methods of cutting the glass substrate member without using the two types of apparatuses of “scriber” and “breaker”, there exist a dice cutting and a laser cutting. However, the dice cutting cannot be adopted in the condition where water is not available. The laser cutting cannot also be used in case where heat may have an effect on the thin film. For these reasons, the cutting method of putting a scratch on the mother glass and splitting the glass under pressure has generally been employed.

### DISCLOSURE OF THE INVENTION

However, the cutting method of putting a scratch on the mother glass and splitting the glass under pressure requires the two types of apparatus, i.e., the “scriber” and “breaker”. Moreover, this method may generate chipped recesses (or broken edges) on the back surface of the glass substrate member when the cutting operation is performed with the use of the breaker, thus requiring a chamfering step for grinding the chipped part.

Therefore, an object of the present invention is to provide a method for cutting the glass substrate member, which is capable of cutting the glass substrate member while forming a scribe line with the “scriber” and obtaining a high-quality and hard-to-chip cutting plane.

When a molten glass is cooled down to become glass, compression stress occurs in the vicinity of the surface of the glass substrate member and tensile stress occurs in the interior of the glass substrate member. Such a phenomenon in which a compressed layer is generated in the vicinity of the surface and a tensile layer is generated in the interior thereof is inherent in the glass substrate member. The inventor of the present invention has paid attention to the fact that a crack does not easily expand in the compressed layer, but the crack expands rapidly in the tensile layer, and found that a high-quality and hard-to-chip cutting plane can be obtained by removing previously the compressed layer from the back surface side of the glass substrate member, wherein the crack is hard to break therethrough, and then forming the scribe line that produces the crack extending to the back surface of the glass substrate member on the front surface of the glass substrate member.

According to the present invention, the above-mentioned object can be achieved by a method for cutting a glass substrate member comprising: a removing step for removing a part or whole of a back surface portion of the glass substrate member; and a scribing step for forming a scribe line that produces a crack on a front surface of the glass substrate member, said crack extending to a back surface of the glass substrate member.

With respect to a step for removing a part or whole of the back surface portion of the glass substrate member, there is etching or chemical treatment such as chemical polishing.

With respect to a step for forming the scribe line on the front surface of the glass substrate member, there is a step for moving a tool coming in contact with the glass substrate member over the front surface of the glass substrate member, while vibrating same in a direction intersecting the front surface of the glass substrate member. When the scribe line is formed in this manner, the crack is easy to generate along the scribe line in the vertical direction to the front surface of the glass substrate member.

The scribing step may comprise forming a plurality of scribe lines, which are in parallel to each other so as to intersect at right angles. In addition, the scribe line may be formed in the form of a closed curve.

The above-mentioned removing step may comprise removing only the part corresponding to the scribe line, so as to leave the compressed layer on the back surface in a maximum amount and enhance the strength of the cut glass substrate.

The present invention further includes a method for cutting glass substrate members comprising: a removing step for removing a part or whole of each back surface portion of two glass substrate members; a step for stacking the two glass substrate members so that back surfaces of the two glass substrate members face to each other; and a scribing step for forming a scribe line that produces a crack on each front surface of the stacked glass substrate members, said crack extending to a back surface of each of the glass substrate members.

The present invention is especially suitable for cutting a thin glass substrate member used for liquid crystal display or organic EL display.

### BRIEF DESCRIPTION OF THE DRAWINGS

FIG. 1 is a schematic view showing compression stress and tensile stress exerting on a glass substrate member;

FIG. 2 is a conceptual view of a method for cutting a glass substrate member in accordance with an embodiment of the present invention;

FIG. 3 is a cross-sectional view of a glass substrate member (in case where only a part of a back surface portion is removed);

FIG. 4 is a cross-sectional view of a glass substrate member (in case where a circular glass substrate is to be cut out);

FIG. 5 is a top plan view of a glass substrate member (in case where a scribe line for a circular closed curve is formed);

FIG. 6 is a top plan view of the glass substrate member (in case where scribe lines intersecting at right angles are formed);

FIG. 7 is a cross-sectional view of a comparative example in which a scribe line is formed on a front surface without removing a compressed layer;

FIG. 8 is a schematic cross-sectional view of a liquid crystal display;

FIG. 9 is a schematic cross-sectional view of an organic EL display;

FIG. 10 is a conceptual view of a cutting method in case where two glass substrate members are place one upon another;

FIG. 11 is an enlarged view showing a cutting plane of the glass substrate member cut by the cutting method in accordance with this embodiment;

FIG. 12 shows a comparative example in which cracks occurring in the scribing step do not extend to the back surface of the glass substrate member;

FIG. 13 shows a comparative example in which a circular glass substrate member is cut by using conventional “scriber” and “breaker”; and

FIG. 14 is a graph showing Weibull distribution in glass strength.

### BEST MODE FOR CARRYING OUT THE INVENTION

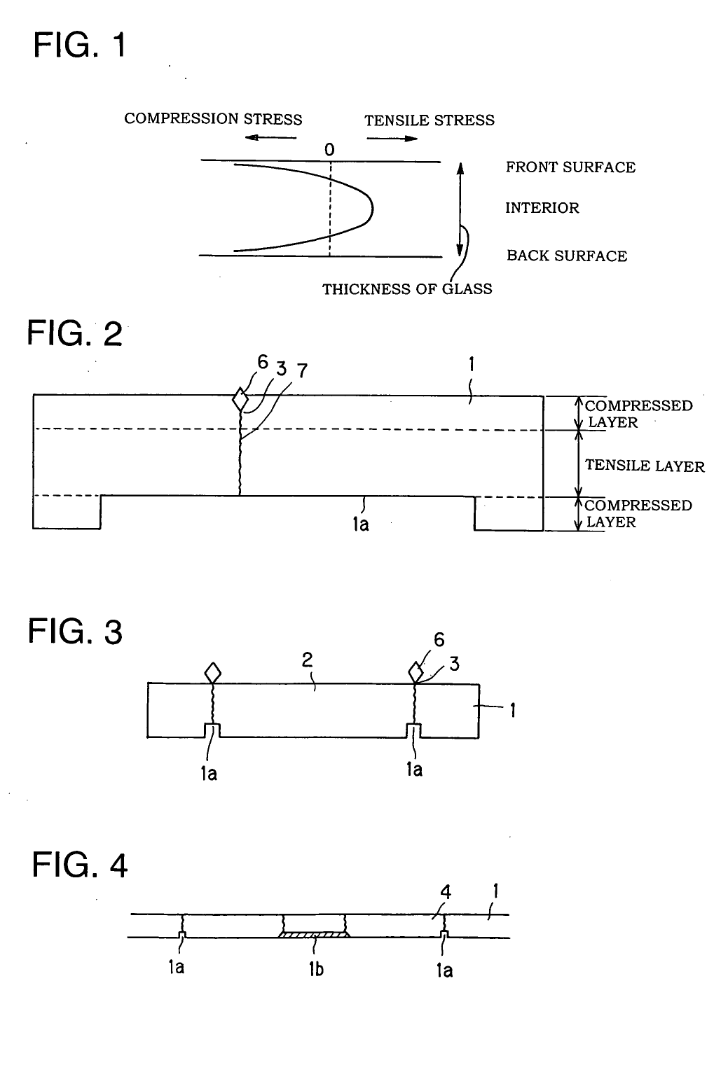

A compressed layer and a tensile layer of a glass substrate member (that is, mother glass) will be described. The glass substrate member is manufactured by cooling molten glass, which has been subjected to heating at high temperature according to a float method, down draw method or the like. While the liquid is getting cold to become glass, temperature in the vicinity of the front surface and back surface decreases more quickly than that of the interior. While the part on the side of the front surface and back surface is becoming hardened, the interior has still fluidity and therefore substance of the interior moves toward the front surface and back surface. As a result, there is provided a state where the part on the side of the front surface and back surface has a higher density than the interior. Subsequently, as schematically shown in FIG. 1, compression stress occurs on the side of the front surface and back surface and tensile stress occurs in the interior. The area where compression stress occurs is called a “compressed layer” and the area where tensile stress occurs is called a “tensile layer”. The thickness of the compressed layer varies depending on the cooling process, material and the like, and is about 7 to 15% of the whole thickness, for example.

A method for cutting the glass substrate member in accordance with an embodiment of the present invention will be described. FIG. 2 is a conceptual view of the method for cutting the glass substrate member. First, a glass substrate member 1 manufactured according to the above-mentioned float method, down draw method or the like is prepared. Material of the glass substrate member 1 is not limited specifically and various materials such as soda lime glass, borosilicate glass, low-alkali glass, no alkali glass and silica glass can be used in accordance with use. For the glass substrate member 1 for liquid crystal display or organic EL display, for example, non-alkali glass containing neither sodium nor potassium is used so that sodium contained in the glass does not dissolve as impurity, when a TFT (thin film transistor) is formed on the front surface of the glass substrate member 1. The thickness of the glass substrate member 1 is not limited specifically and varies in accordance with use. For example, the member of about 0.7 to 1.1 mm in thickness for liquid crystal display, about 2.8 to 3 mm for PDP (plasma display) and about 2.8 to 3 mm for fluorescent display tube are used. Recently, an extremely thin glass substrate member of 0.3 mm has been used for liquid crystal display. Even if the glass substrate member becomes thinner, the above-mentioned compressed layer and tensile layer still exist and the thinner the glass substrate member, the worse the cutting attribute due to the compressed layer.

Next, a part 1a of the back surface portion of the glass substrate member 1 is removed. Here, the glass substrate member 1 is melted by etching or chemical treatment such as chemical polishing to remove the compressed layer on the back surface side. As a solvent for melting the glass substrate member 1, a solvent of hydrofluoric acid, for example, is used. The whole back surface portion of the glass substrate member 1 may be removed or part of the back surface portion may be removed as shown in FIG. 1. Alternatively, as shown in FIG. 3, only the part 1a corresponding the scribe line 3 may be removed in the shape of groove by etching using a resist as a mask so as to leave the compressed layer on the back surface side of the glass substrate member to be cut. Alternatively, when cutting out a circular glass substrate as shown in FIG. 4, a part 1b, which is placed at an inner side than the inside perimeter of the glass substrate 4 may be removed. As there is a possibility that the cut glass substrates 2, 4 composed of only the compressed layer and tensile layer may warp, the compressed layer is left on the back surface side of the glass substrates 2, 4 so as to prevent warp and ensure the strength of the glass substrates 2, 4.

Preferably, the depth to which the glass substrate material 1 is removed is the whole length of the compressed layer in the thickness direction, but part of the length in the thickness direction is applicable. Specifically, the width of etching is set to be 100 μm or less, for example, and the depth is set to be about 1.5 to 2 times larger than the width.

When the strength of the glass substrates 2, 4 is not required, the compressed layers on the front surface side as well as the back surface side of the glass substrates member 1 may be removed. However, in view of the fact that a chipped recess hardly occurs on the surface when adopting the scribing method described later in which a tool is vibrated and that the removed part may provide unevenness when the tool is moved, it is preferable to remove only the compressed layer on the back surface side.

Next, as shown in FIG. 2, the scribe line that generates a crack extending to the back surface of the glass substrate member is formed on the front surface of the glass substrate member 1. In the scribing step, a tool 6 that comes into contact with the glass substrate member 1 is moved over the front surface of the glass substrate member 1 while vibrating the tool in the direction intersecting the front surface of the glass substrate member, for example, in a perpendicular direction to the front surface thereof. As a result, a crack 7 extends in the perpendicular direction to the front surface of the glass substrate member 1 along the scribe line more deeply than the cut by the tool 6. For example, a diamond tool having a quadrangular pyramid shape or a wheel tool having an abacus-bead shape may be used as the tool 6. To vibrate the tool, for example, a piezoelectric element (piezo-actuator) that generates distortion with the application of an electric field is used. Although it is desirable that the tool 6 is vibrated so as to form a deep vertical crack, the tool 6 need not necessarily be vibrated.

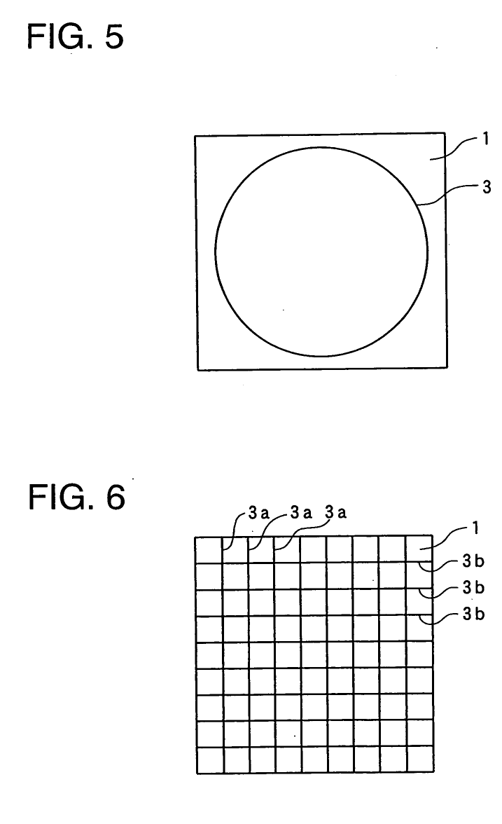

FIG. 5 and FIG. 6 show top plan views of the glass substrate member 1. Scribe lines 3, 3a and 3b are formed in various manners according to the shape of the glass substrate to be cut. Specifically, the scribe line 3 may be formed in a closed curve such as a circle or oval as shown in FIG. 5 or a plurality of scribe lines 3a parallel to each other and lines 3b parallel to each other may be formed so as to intersect at right angles as shown in FIG. 6.

In case where the glass substrate member is cut by using the conventional “scriber” and “breaker”, causing the plurality of scribe lines to intersect each other makes the vertical cracks deeper at the intersecting corner portions than the non-intersecting parts. This variation in depth of vertical cracks becomes one of factors for generation of chipped recesses and the like in the corner portions at the time of the splitting with the use of the “breaker”. Further, when the scribe line is formed in a closed curve, a step for removing the inner side of the closed curve from the glass substrate member by the “breaker” is required and chipped recesses easily occur on the back surface side of the glass substrate member in the process.

As shown in FIG. 2, when the scribe line 3 is formed on the glass substrate member 1, the vertical crack 7 occurs along the scribe line 3 simultaneously. Once the vertical crack 7 breaks through the compressed layer on the front surface side, the crack 7 moves through the interior tensile layer rapidly. Although the vertical crack 7 has much difficulty in breaking through the compressed layer on the back surface side, as the compressed layer on the back surface side of the glass substrate member 1 has been already removed, the vertical crack 7 extends to the back surface of the glass substrate member 1 easily and cuts (separates) the glass substrate member 1 without using the “breaker”. Further, by removing the compressed layer on the back surface side, rectangularity of the vertical crack 7 with respect to the front surface and back surface of the glass substrate member 1 can be improved, thereby to prevent chipped recesses and the like from generating. For this reason, there is no need to carry out a chamfering step in which the chipped recesses and the like are to be polished in the subsequent step. Moreover, in comparison with the case where the glass substrate member is cut only in the scribing step, a processing pressure, which is applied to the tool when forming the scribe line on the front surface of the glass substrate member, can be decreased. As a result, damage on the front surface of the glass substrate member such as horizontal cracks can be reduced, resulting in further improvement in quality and a decrease in load during a subsequent cleaning step.

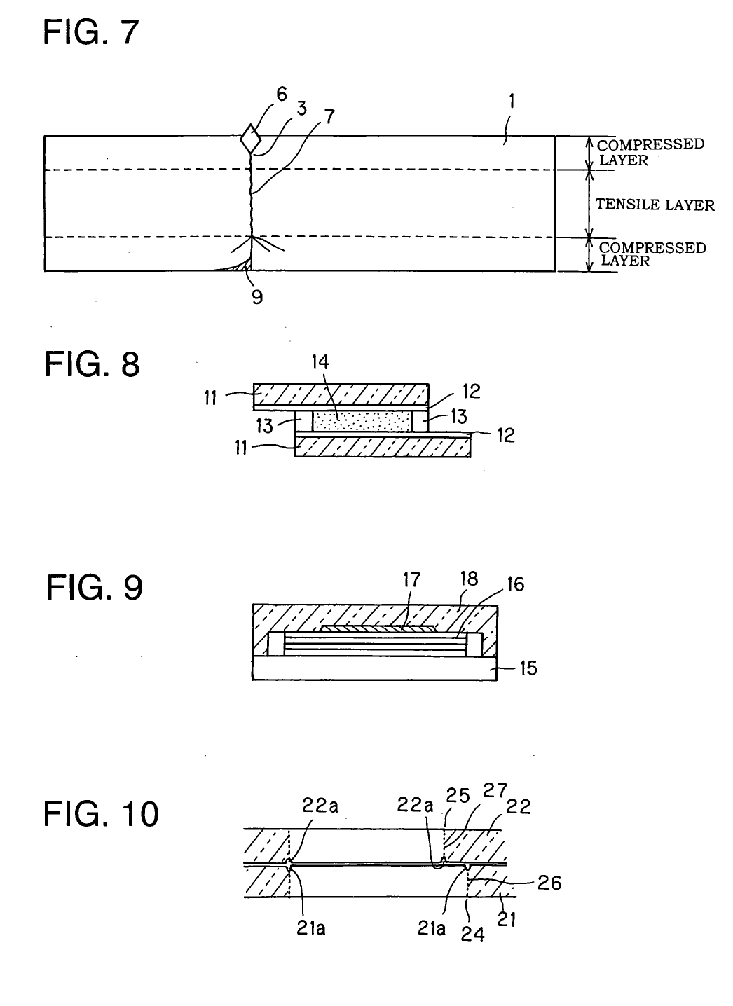

FIG. 7 shows a comparative example in which the scribe line is formed on the front surface without removing the compressed layer from the back surface of the glass substrate member 1. When the compressed layer remains on the back surface side of the glass substrate member 1, the vertical crack 7, which occurs along the scribe line, stops just short of the compressed layer on the back surface side or becomes cracks dispersed non-vertically even if they extend to the compressed layer. For this reason, when the member is split by the “breaker”, the back surface can get chipped at the front surface side thereof, thereby generating chipped recesses (shaded area in the figure). Further, when an attempt to cut the glass substrate member 1 only in the scribing step is made, a strong force is required and the cut surface becomes uneven, thus causing problems.

As shown in FIG. 8, a liquid crystal display is generally fabricated by forming, for example, TFTs (thin film transistors) 12, 12 on two thin glass substrates 11, 11, respectively, attaching a sealant 13 around the stacked two glass substrates 11, 11, and injecting liquid crystal 14 between the glass substrates 11, 11. Further, as shown in FIG. 9, an organic EL display is generally fabricated by deposition-forming thin films 16 such as electrodes and luminescent layers on a thin glass substrate 15 by deposition or the like, filling it with a desiccant 17 and covering the glass substrate 15 on which the thin films have been deposited, with another glass substrate 18 serving as a cover. A cutting method in case where the two glass substrates are stacked in this manner will be described below.

FIG. 10 is a conceptual view of a cutting method in case where two glass substrate members 21, 22 are stacked. As in the above-mentioned cutting method, parts 21a and 22a of the each back surface portion of the two glass substrate members 21, 22 are firstly removed. Next, the two glass substrate members 21, 22 are stacked so that the back surfaces of the glass substrate members 21, 22 face to each other. This stacking step is determined appropriately in accordance with use of the glass substrate member such as a liquid crystal display and an organic EL display. When they are stacked, the back surfaces of the glass substrate members 21, 22 may be in contact with each other or not in contact with each other. Then, scribe lines 24 and 25 are formed on each front surface of the stacked glass substrate members 21, 22. In this scribing step, cracks 26, 27 occurring along the scribe lines 25, 26 extend to the back surface of the glass substrate members 21, 22 so that the glass substrate members 21, 22 are cut.

In the above-mentioned embodiment, the method for cutting the glass substrate member mainly for the liquid crystal display and the organic EL display is described, but the method for cutting the glass substrate member according to the present invention is not necessarily limited to only the glass substrate member for the liquid crystal display and the organic EL display and may be applied to various glass substrate members containing the compressed layer and tensile layer.

### EXAMPLE

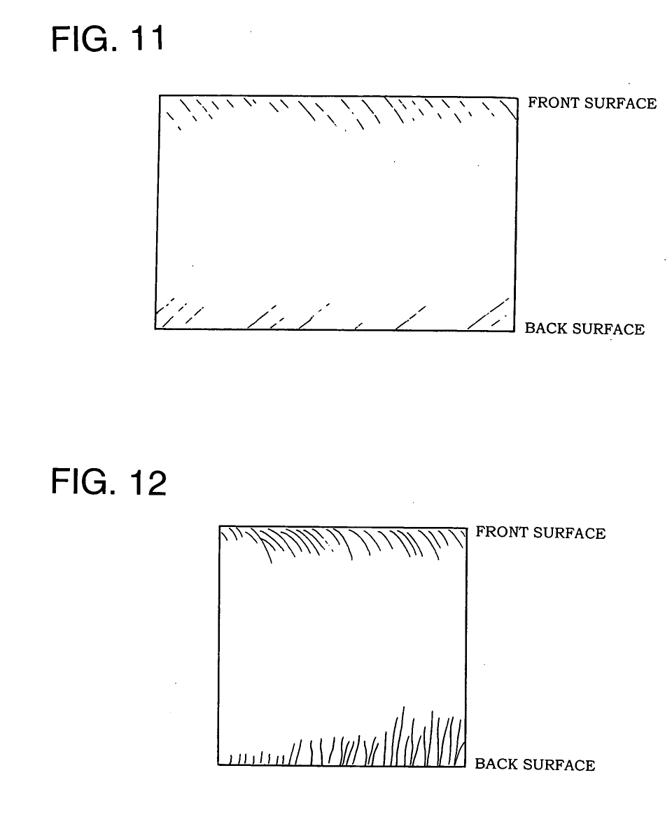

FIG. 11 shows an enlarged view showing a cutting plane of the glass substrate member cut by the cutting method according to this embodiment. The compressed layer on the back surface side of the glass substrate member is removed by chemical polishing and the scribe lines, along which cracks extend to the back surface, are formed by using a vibrating tool at the front surface. A high-quality cutting plane without chipped recess or fine cracks can be obtained.

### COMPARATIVE EXAMPLE

FIG. 12 shows a comparative example in which cracks occurring in the scribing step do not extend to the back surface side of the glass substrate member. It demonstrates that when the glass substrate member is separated by the conventional “breaker”, a lot of fine cracks are generated on the back surface side of the glass substrate member.

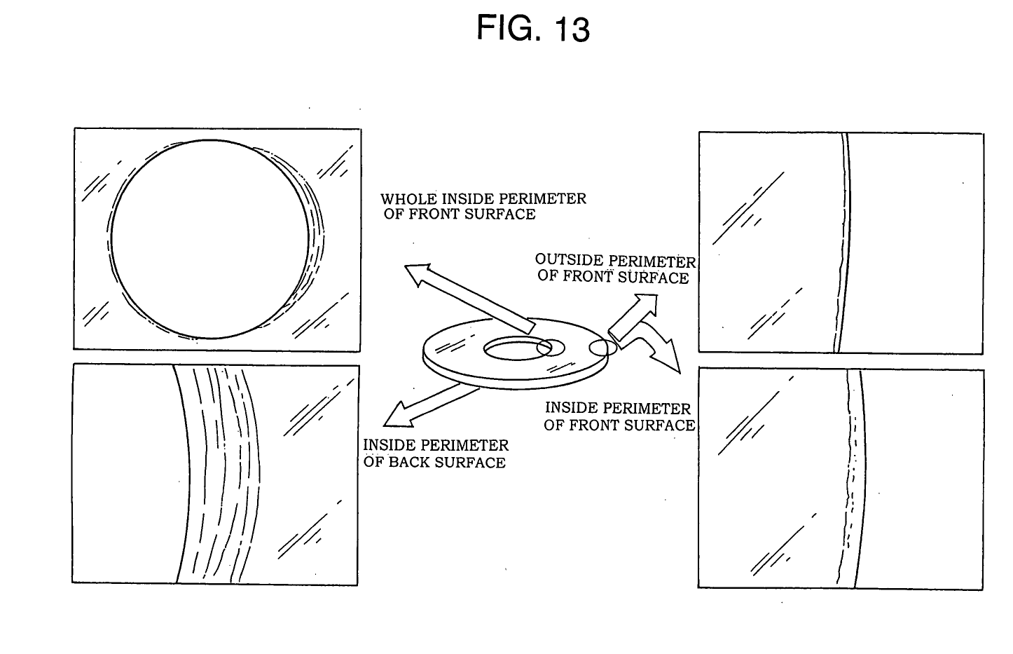

FIG. 13 shows a comparative example in which a circular glass substrate member is cut by using the conventional “scriber” and “breaker”. A circle of the inside perimeter side and a circle of the outside perimeter side are formed by the “scriber” and the circular glass substrate member is removed by the “scriber”. Four detailed views are enlarged views of the chipped recess at each part (whole inside perimeter of the front surface, inside perimeter of the back surface, outside perimeter of the front surface and inside perimeter of the front surface). These figures prove that the back surface side of the glass substrate member has a larger chipped recess than the front surface side of the glass substrate member.

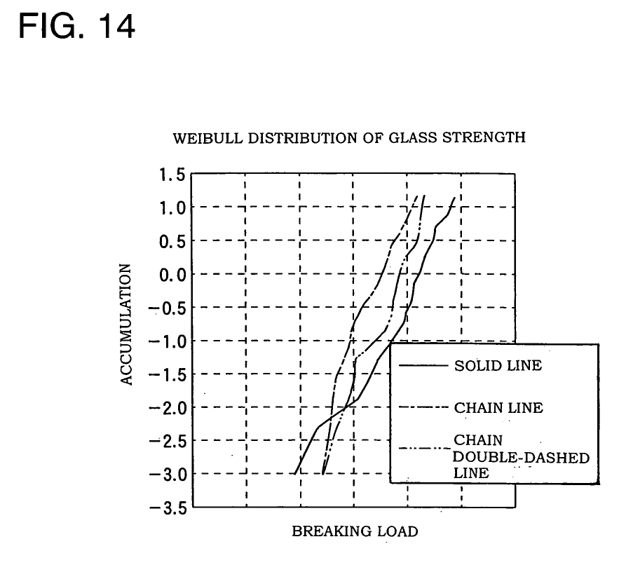

FIG. 14 is a graph showing Weibull distribution of glass strength. A horizontal axis represents breaking load and a vertical axis represents accumulation. After cutting of the glass substrate member by using the conventional “scriber” and “breaker”, a comparison is made in glass strength between the case where the cutting plane is chamfered and the case where the cutting plane is not chamfered. A solid line in the figure represents the case where the cutting plane is not chamfered and a chain line and a chain double-dashed line represent the case where the cutting plane is chamfered. The chain line is different from the chain double-dashed line in roughness of grinding.

It is apparent from this graph that the strength as a whole is slightly decreased but variation in strength is reduced by chamfering. Variation in strength become larger in case where the cutting plane is not chamfered seems to be caused due to fine cracks occurring on the back surface of the glass substrate member. Decrease in strength in case where the cutting plane is chamfered seems to be caused due to fine cracks newly occurring by grinding.

On the contrary, according to the cutting method of this embodiment, as the chamfering step becomes unnecessary, the strength does not decrease and no fine cracks occur, resulting in reduction in variation in strength.

As described above, according to the present invention, as the compressed layer on the back surface side of the glass substrate member is removed in advance and then the scribe line that produces a crack extending to the back surface of the glass substrate member is formed on the front surface of the glass substrate member, a high-quality and hard-to-chip cutting plane can be obtained.

1. A method for cutting a glass substrate member comprising:
a removing step for removing a part or whole of a back surface portion of the glass substrate member; and
a scribing step for forming a scribe line that produces a crack on a front surface of the glass substrate member, said crack extending to a back surface of the glass substrate member.

2. The method for cutting a glass substrate member according to claim 1, wherein: said removing step comprises removing the back surface portion of the glass substrate member through application of etching or chemical treatment such as chemical polishing.

3. The method for cutting a glass substrate member according to claim 1 or 2, wherein: said scribing step comprises moving a tool coming in contact with the glass substrate member over the front surface of the glass substrate member, while vibrating same in a direction intersecting the front surface of the glass substrate member.

4. The method for cutting a glass substrate member according to claim 3, wherein: said scribing step comprises forming a plurality of scribe lines, which are in parallel to each other so as to intersect at right angles.

5. The method for cutting a glass substrate member according to claim 3, wherein: said scribing step comprises forming the scribe line in a form of a closed curve.

6. The method for cutting a glass substrate member according to claim 1 or 2, wherein: said removing step comprises removing only the part corresponding to the scribe line.

7. A method for cutting glass substrate members comprising:
a removing step for removing a part or whole of each back surface portion of two glass substrate members;
a step for stacking the two glass substrate members so that back surfaces of the two glass substrate members face to each other; and
a scribing step for forming a scribe line that produces a crack on each front surface of the stacked glass substrate members, said crack extending to a back surface of each of the glass substrate members.

8. The method for cutting a glass substrate member according to claim 1, 2, or 7, wherein the glass substrate member is a glass substrate member for a liquid crystal display or an organic EL display.
